(19) United States
(12) Patent Application Publication
(10) Pub. No.: US 2005/0086867 A1
(43) Pub. Date: Apr. 28, 2005

(54) Access door

(76) Inventor: Gunter Langenhorst, Soest (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/944,680

(22) Filed: Sep. 17, 2004

(30) Foreign Application Priority Data
Sep. 19, 2003 (DE) 10343391.0

(51) Int. Cl. E05D 7/00

(52) U.S. Cl. 49/400

(57) ABSTRACT

An access door has a rectangular outer frame adapted to be set in a wall and having two longitudinal sides and two transverse sides defining four corners and a rectangular inner frame dimensioned to fit within the outer frame. Respective hinge plates fixed at corners at ends of one of the longitudinal sides of the inner frame each have an outer part bearing outward on a back face of the outer frame for holding the inner frame in the outer frame and for pivoting of the inner frame in the outer frame generally about the one longitudinal side. Each of the plates is formed with a transversely outwardly open centering notch. Respective centering tabs on the outer frame are engageable in the centering notches of the hinges.

### FIELD OF THE INVENTION

The present invention relates to an access door. More particularly this invention concerns a hatch or panel that is set in a ceiling or wall to allow occasional access to plumbing, wiring, or the like behind the ceiling or wall.

### BACKGROUND OF THE INVENTION

In construction it is frequently necessary to provide occasional access to valves, switches, punch-down blocks, and the like that are behind the wall or ceiling. Such a door typically comprises an outer frame that is permanently set in the wall and an inner frame and panel that are secured to the outer frame by hinges along one edge and a releasable latch along an opposite is edge. The access door need not be complex, as it is used infrequently, but must be unobtrusive when installed, that is typically be flush so it can be finished like the wall, and centered in its opening so it presents a nice appearance.

Thus a standard access door comprises as described in German patent 37 36 060 or EP 0,567,731 a pair of annular L-section frames, one within the other. The outer wall frame is typically set permanently in the wall, and the inner panel frame is adapted to hold a wall or ceiling panel and is releasably retained in the wall frame by some sort of hinge/latch assembly. In a typical installation the panel frame is adapted to hold one or two thicknesses of standard gypsum board, with in some instances a thin steel plate on the back face of the inset panel. The frames are formed with centering bumps that keep the inner frame at a uniform spacing withing the outer frame.

### OBJECTS OF THE INVENTION

It is an object of the present invention to provide an improved access door.

Another object is the provision of such an improved access door whose center panel assembly is perfectly centered in the outer frame.

### SUMMARY OF THE INVENTION

An access door has according to the invention a rectangular outer frame adapted to be set in a wall and having two longitudinal sides and two transverse sides defining four corners and a rectangular inner frame congruent to the outer frame, having longitudinal and transverse sides and four corners, and dimensioned to fit within the outer frame. Respective hinge plates fixed at corners at ends of one of the longitudinal sides of the inner frame each have an outer part bearing outward on a back face of the outer frame for holding the inner frame in the outer frame and for pivoting of the inner frame in the outer frame generally about the one longitudinal side. Each of the plates is formed with a transversely outwardly open centering notch. A latch is engaged between the inner and outer frames at a longitudinal side opposite the one longitudinal side. Respective centering tabs on the outer frame are engageable in the centering notches of the hinges.

Thus the hinges are modified to take care of at least part of the centering function. When the door is provided with a hold down plate between its hinges, according to the invention, this is done by providing inner and outer centering plates on the one longitudinal side between the hinges, one of the plates being formed with a central centering tab and the other of the plates being formed with a central centering notch in which the central tab is fitted in a closed position of the inner frame.

According to the invention, in a position of the inner frame centered in the outer frame, the centering tabs of the hinges fit with longitudinal play but with transverse abutment in the centering notches of the hinges and the central centering tab fits with transverse play but with longitudinal abutment in the central centering notch. In this manner the central structure—that is the inner frame and the panel it carries—is accurately centered at least at one of the longitudinal sides in the outer frame. Since the transverse and longitudinal centering are done by different parts, they do not have to be mounted at closely determined tolerances relative to each other.

The central centering tab has a rearwardly bent outer end according to the invention that serves for fitting the inner frame into the outer frame. In addition the hinge plates have longitudinal extensions formed with the respective notches.

According to another feature of the invention two transversely effective spring latches are provided at the other longitudinal side near ends thereof between the inner and outer frames, and two longitudinally effective spring latches are also provided at the transverse sides near the other longitudinal side between the inner and outer frames. These spring latches serve to press the inner frame into the centering formations on the outer frame and ensure perfect centering of the inner frame when fitted to the outer frame.

### BRIEF DESCRIPTION OF THE DRAWING

The above and other objects, features, and advantages will become more readily apparent from the following description, reference being made to the accompanying drawing in which:

FIG. 1 is a rear view of the access door according to the invention in the closed position;

FIG. 2 is a horizontal section through the access door in partly open condition;

FIGS. 3 and 4 are views from inside showing the latches of the door; and

FIG. 5 is a back view of one of the latches during opening of the door.

### SPECIFIC DESCRIPTION

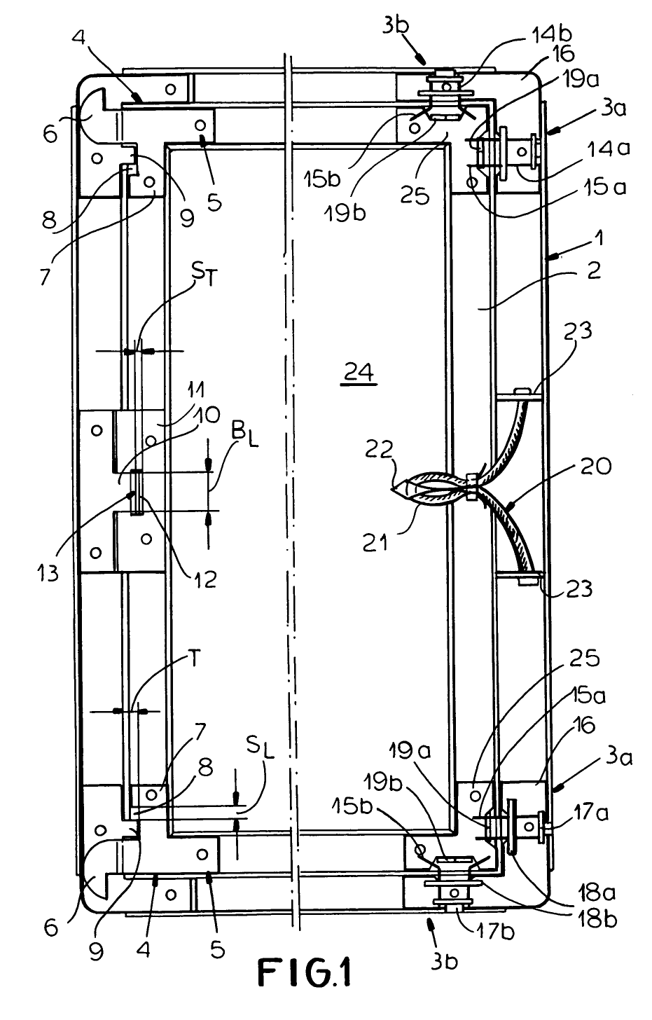

As seen in FIG. 1 an access door according to the invention has an outer L-section metal frame adapted to be secured permanently in a wall or ceiling and an inner frame 2 also metallic and of L-section and holding a panel 24, e.g. a piece of fire-code gypsum board. Both the frames 1 and 2 are rectangular and have a back flange lying parallel to a wall plane and another flange perpendicular thereto. The inner frame 2 is secured in the outer panel 1 by two latches 3a along one longitudinal edge, two further latches 3b along opposite shorter is transverse edges adjacent the latches 3a, and corner hinges 4 on ends of the long edge opposite the edge with the latches 3a. The term “longitudinal” here refers to the vertical direction as seen in FIG. 1 and “transverse” to the horizontal direction.

More particularly, the corner hinges 4 each comprise a rigid flat leaf 5 spot welded to a back face of the back flange inner frame 2 and a coplanar and rigid flat outer leaf 6 that lies against the back face of the back flange of the outer frame 1 and is of hook shape so that the inner frame 2 has to be canted to be fitted through the outer frame 1. In addition each hinge 4 forms on the frame 2 an outwardly and transversely open notch 8 into which fits an inwardly and transversely projecting tab or tooth 9 mounted on the outer frame 1. The notches 8 each have a longitudinal width greater by a spacing S_{L} than a longitudinal width of the respective tooth 9, but the tooth 9 has a transverse dimension T that is such that when the frame 2 is perfectly transversely centered in the frame 1, its outer end bottoms on the floor of the notch 8.

The frame 2 carries centrally between the hinges 4 a centering plate 11 formed with a central transversely outwardly open notch 10 into which fits a tab or tooth 12 carried on the outer frame. Both the notch 10 and tooth 12 are of the same longitudinal width B_{L} so that the tooth 10 fits snugly in the notch 12 when the frame 2 is perfectly longitudinally centered in the frame 1. The tooth 12 is, however, shorter transversely by a transverse spacing S_{T} than the depth of the notch 12. Thus transverse centering of the frame 2 is taken care of by the two tabs 9 in the notches 8 and longitudinal spacing is the job of the center tab 10 in the notch 12. The inner end of the tab 12 is bent back at 13 to facilitate fitting of the inner frame 2 into the outer frame 1.

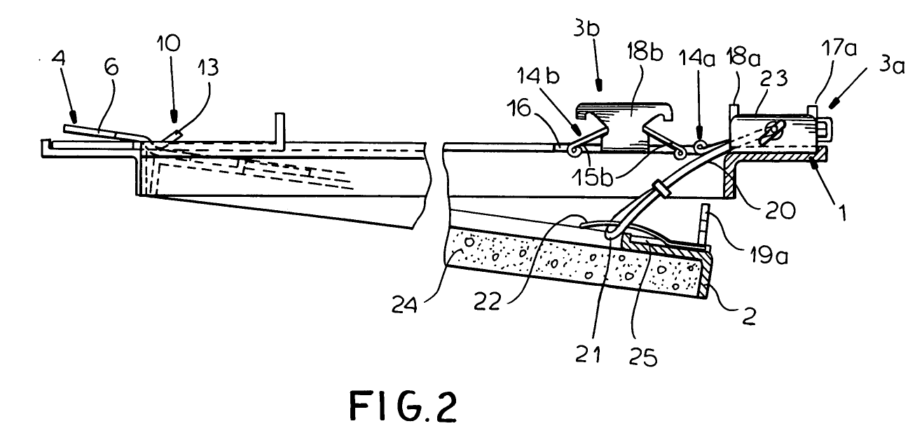

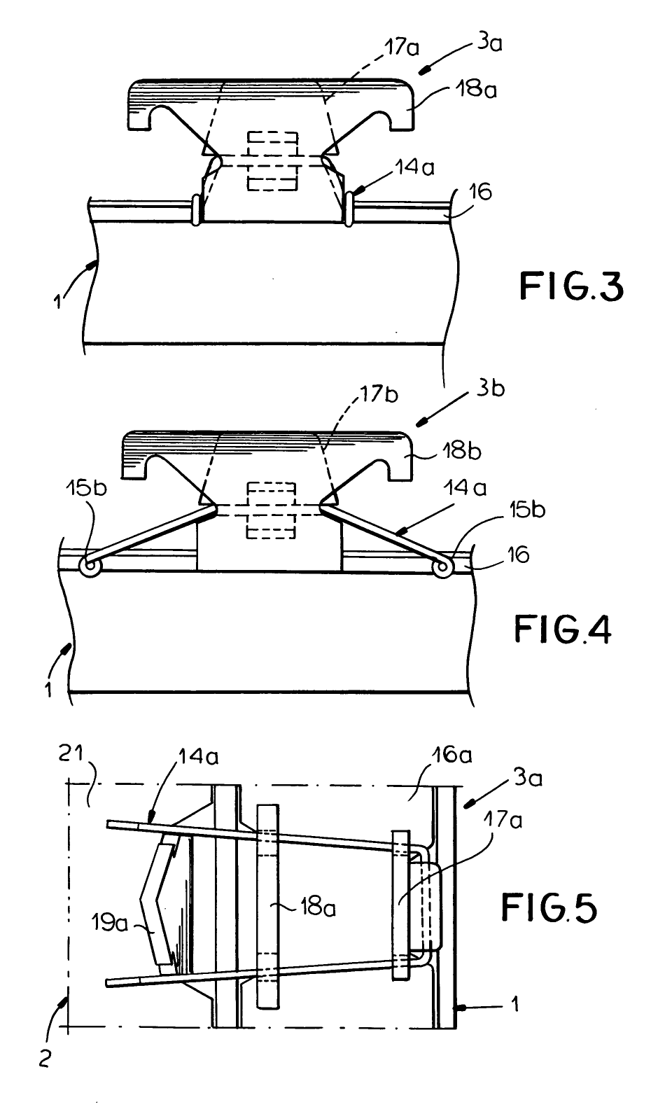

The latches 3a and 3b are identical and mounted on angle plates 16 at the respective corners of the outer frame 1 and similar angle plates 25 fixed to the corresponding corners of the inner frame 2. These latches 3a and 3b have respective U-shaped springs 14a and 14b with bights seated in pivot eyes 17a and 17b bent outward from the respective outer plates 16 and two arms 15a and 15b that pass through guide plates 18a and 18b also bent outward from the outer plates 16 and that engage tongues 19a and 19b bent outward from the inner plates 25. The arms 15a and 15b, whose ends can be formed as eyes, bear on the respective tongues 19a and 19b so as to push them away. Thus the latches 3a spring-bias the inner frame 2 transversely toward the left as seen in FIG. 2, thereby pressing the tabs 9 into the floors of the grooves 8, while the latches 3b similarly center the inner frame 2 longitudinally. The tongues 19a and 19b are also shaped to receive the arms 15a and 15b of the springs 14a and 14b such that when fitted together there is not only this transverse and longitudinal centering effect but there is also in/out positioning to ensure the frame 2 is coplanar with the frame 1 is and releasably retained in the FIG. 1 closed position.

Midway between the latches 3a there is a further latch 20 comprised of a flexible strand or element 20 having its ends seated in symmetrically arranged brackets 23 fixed on the back flange of the outer frame 1 and forming a loop 21 engageable over a hook 22 provided on the back face of the back flange of the inner frame 2. The strand 20 is elastomeric so that, when engaged over the hook 22, it holds the inner frame 2 in the FIG. 1 closed position, but the inner frame 2 can be pivoted out as shown in FIG. 2 with elastic elongation of the strand 20 sufficiently that it can be unhooked and the frame 2 and panel 24 can be taken out of the outer frame 1. During such outward pivoting the arms 15a and 15b are pulled off the keeper tongues 19a and 19b.

The access door according to the invention is open as described in above-cited German 37 36 060 by pushing in on one or both of the corners with the latches 3a and 3b so that the door assembly formed by the frame 2 and panel 24 pops out slightly, allowing it to be pulled open wide enough to unhook the strand 20 and pivot it all the way out.

1. An access door comprising:
a rectangular outer frame adapted to be set in a wall and having two longitudinal sides and two transverse sides defining four corners;
a rectangular inner frame congruent to the outer frame, having longitudinal and transverse sides and four corners, and dimensioned to fit within the outer frame;
respective hinge plates fixed at corners at ends of one of the longitudinal sides of the inner frame and each having an outer part bearing outward on a back face of the outer frame for holding the inner frame in the outer frame and for pivoting of the inner frame in the outer frame generally about the one longitudinal side, each of the plates being formed with a transversely outwardly open centering notch;
a latch engaged between the inner and outer frames at a longitudinal side opposite the one longitudinal side; and
respective centering tabs on the outer frame and engageable in the centering notches of the hinges.

2. The access door defined in claim 1 further comprising
inner and outer centering plates on the one longitudinal side between the hinges, one of the plates being formed with a central centering tab and the other of the plates being formed with a central centering notch in which the central tab is fitted in a closed position of the inner frame.

3. The access door defined in claim 2 wherein, in a position of the inner frame centered in the outer frame, the centering tabs of the hinges fit with longitudinal play but with transverse abutment in the centering notches of the hinges and the central centering tab fits with transverse play but with longitudinal abutment in the central centering notch.

4. The access door defined in claim 2 wherein the central centering tab has a rearwardly bent outer end.

5. The access door defined in claim 1 wherein the hinge plates have longitudinal extensions formed with the respective notches.

6. The access door defined in claim 1, further comprising:
two transversely effective spring latches at the other longitudinal side near ends thereof between the inner and outer frames; and
two longitudinally effective spring latches at the transverse sides near the other longitudinal side between the inner and outer frames.

7. The access door defined in claim 6 wherein each of the latches is provided with a spring seated in one of the frames and bearing on the other of the frames.

8. The access door defined in claim 7 wherein each of the springs is fixed to the one frame and each of the latches includes a keeper tongue on the other frame and in which the respective spring is seated in a closed position of the door to hold the inner frame in the outer frame.

9. The access door defined in claim 8 wherein each of the springs is generally U-shaped and has a bight secured to the one frame and a pair of arms bearing on the keeper tongue of the other frame.

10. The access door defined in claim 8 wherein each of the keeper tongues is a tab bent outward from and fixed to the other frame.

11. The access door defined in claim 8 wherein the springs of the transverse latches bear transversely inward on the inner frame and the springs of the longitudinal latches bear longitudinally inward on the inner frame.

12. The access door defined in claim 1, further comprising:
an elastomeric retaining loop mounted on one of the frames at the longitudinal side opposite the one side; and
a hook on the other frame adjacent the loop and over which the loop is engageable to hold the inner frame in a closed position.

13. The access door defined in claim 12 wherein the loop is fixed to the outer frame and the hook is on the inner frame.

14. The access door defined in claim 12 wherein the loop and hook are provided generally centrally between the corners of the respective sides.
